(19) United States
(12) Patent Application Publication
(10) Pub. No.: US 2005/0216714 A1
(43) Pub. Date: Sep. 29, 2005

(54) Method and apparatus for predicting confidence and value

(75) Inventor: Edward T. Grochowski, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/809,957

(22) Filed: Mar. 25, 2004

(51) Int. Cl. G06F 9/00

(52) U.S. Cl. 712/240

(57) ABSTRACT

A method and apparatus for making predictions which give a predicted value and also a confidence value is presented. In one embodiment, a global confidence history is maintained. The global confidence history may be hashed with an instruction pointer to form an index into a pattern history table or tables that include local histories of confidence values and predicted values. The outputs of the pattern history tables may be used to form confidence values and predicted values.

### FIELD

The present disclosure relates generally to microprocessors that employ predictors, and more specifically to microprocessors wishing to employ predictors showing how much confidence the predictor has concerning a particular prediction value.

### BACKGROUND

Modem microprocessors may support the use of predictors in their architectures. The predictor may make possible early decisions that are dependent upon a value calculated at some future time. When the predictor is accurate, the early decisions may enhance processor performance. Many predictors give a prediction value for a branch instruction (i.e. “taken” or “not taken”). In other situations, the predictors may give a prediction value for a qualifing predicate value (i.e. either “predicate value true” or “predicate value false”). Many other situations can be envisioned in which a prediction value may be helpful by making possible an early decision during the execution process.

However, when the prediction is not accurate, processor performance may suffer. In many cases the result of an incorrect prediction is that a recovery process must be performed. An example of this may be the processor's pipeline will be halted, flushed, and restarted from a previous instruction. This may impose a performance degradation offsetting the performance enhancements given by several correct predictions.

In order to better employ predictors, various schemes have been used to supply not only a predicted value but also an indication about how much confidence the predictor places in that predicted value. The previously proposed predictors which included an indication about confidence maintained a history of whether various prediction values were correct or incorrect. Various problems have been associated with such predictors, including the attempt to correlate former incorrect predictions with current confidence.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a processor and its execution pipeline showing a predicate predictor, according to one embodiment.

FIG. 2 is a diagram showing a predictor for producing a confidence value and a predicted value, according to one embodiment.

FIG. 3 is a diagram showing a speculative global history register and an architectural global history register, according to one embodiment.

FIG. 4A is a flowchart of the operation of a predictor, according to one embodiment of the present disclosure.

FIG. 4B is a flowchart of the repair of speculative global history registers by the architectural global history registers, according to one embodiment of the present disclosure.

FIGS. 5A and 5B are schematic diagrams of systems including a processor supporting a predicate predictor and micro-op generator, according to two embodiments of the present disclosure.

### DETAILED DESCRIPTION

The following description describes techniques for making predictions which include both prediction values and associated prediction confidence values. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. In certain embodiments the invention is disclosed in the form of predicting qualifying predicate values for an Itanium® Processor Family (IPF) compatible processor such as those produced by Intel® Corporation. However, the invention may be practiced in other kinds of processors, such as an X-Scale® family compatible processor, that may wish to execute predicated instructions. In other embodiments, a predictor of one embodiment may be configured to be used as a branch predictor, a loop predictor, or as any other kind of predictor where a predicted value and a confidence value for that predicted value may be advantageous. The invention may also be practiced in predicting the outcome of branch instructions in the above processors, or in other processors such as Pentium® compatible processors.

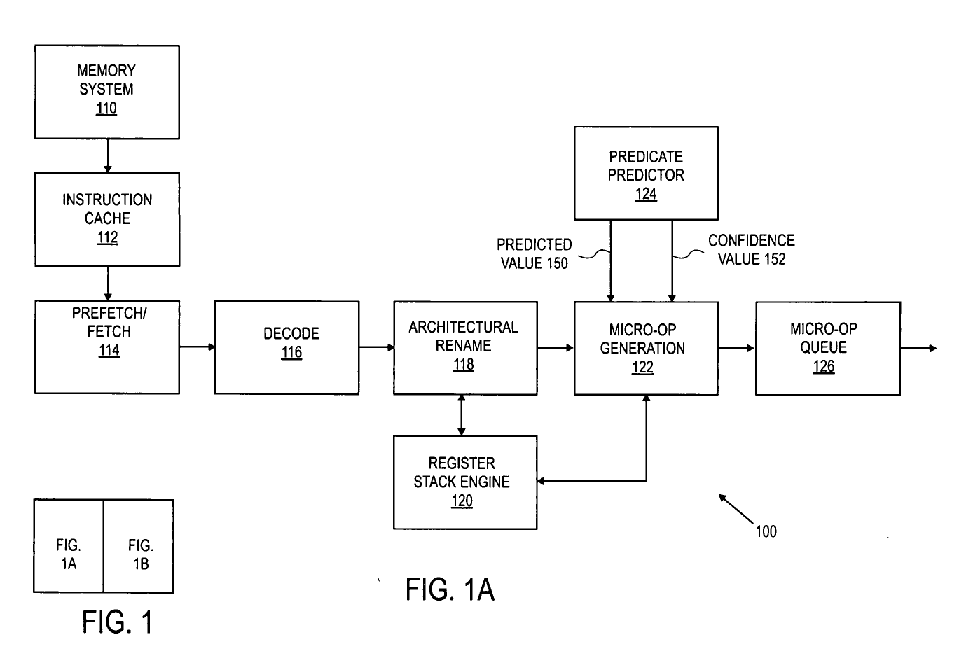

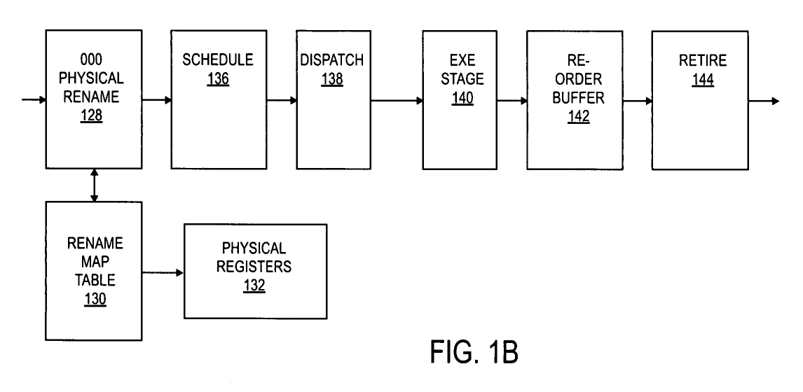

Referring now to FIG. 1, a schematic diagram of a processor and its execution pipeline showing a predicate predictor is shown, according to one embodiment. Instructions may be fetched or prefetched from various levels of instruction cache 112 and memory system 110 by a prefetch/fetch stage 114. The instructions may then be decoded by a decode stage 116. Once decoded, the instructions may have their architecturally-visible registers (i.e. those registers named in software code) renamed to RSE registers by an architectural rename stage 118. In one embodiment, the architectural rename stage 118 is supported by a register stack engine 120 that permits the spilling to the register stack backing store of only those registers actually allocated to a function. In other embodiments, the architecturally-visible registers may be renamed to physical registers without the intermediate RSE register stage.

Once the instructions have their architecturally-visible registers renamed to RSE registers, each instruction may then be represented by a set of one or more micro-operations (micro-ops). The corresponding sets of micro-ops may be issued by a micro-op generation stage 122. The micro-ops may use the RSE register renaming provided by the architectural rename stage 118 and register stack engine 120.

In one embodiment, the set of micro-ops corresponding to an instruction with a predicate may vary depending upon predictions made about the predicate's value by a predicate predictor 124. The predicate predictor 124 may send both a predicate predicted value signal 150 and a confidence value signal 152 to the micro-op generation stage 122. In one embodiment, the predicate predicted value signal 150 may indicate whether the predicted predicate value is either true or false. The confidence value signal 152 may indicate whether the confidence determined for the corresponding predicate predicted value is high or low by indicating true and false. In other embodiments, the confidence value signal 152 may indicate whether the confidence determined for the corresponding predicted predicate value is high or low by indicating a numerical value which the micro-op generation stage 122 may use to determine whether the confidence value is high or low.

When the confidence value signal 152 indicates a high confidence for the predicate predicted value of an instruction, micro-op generation stage 122 may issue one set of micro-ops corresponding to that instruction if the predicate predicted value is “true”, and a different set of micro-ops corresponding to that instruction if the predicate predicted value is “false”. These sets of micro-ops may have simpler data dependencies than a set of micro-ops which may be issued without any prediction of the predicate value. Such a set of micro-ops may be issued when the confidence value signal 152 indicates a low confidence for the predicate predicted value of that instruction.

In other embodiments, the predictor 124 may be configured to be used as a branch predictor, a loop predictor, or in other configurations where a predicted value and a confidence value for that predicted value may be advantageous.

Sets of micro-ops issuing from micro-op generation stage 122 may be held in a micro-op queue 126 prior to having their RSE registers renamed to physical registers in order to support subsequent OOO execution. In one embodiment, an OOO physical rename stage 128 may make use of a rename map table 130 to map RSE registers to physical registers 132. Once the renaming to physical registers is performed, then the micro-ops may be scheduled and dispatched by a schedule stage 136 and a dispatch stage 138, respectively.

The micro-ops may then be executed in an execution stage 140. In one embodiment, execution stage 140 may include several execution units. In one embodiment, these several execution units may be of several specialized types, such as branch execution units, floating point execution units, and integer execution units. It is noteworthy that the actual determination of a predicate value may first be made in the execution stage 140, when the predicate value is calculated. The execution results from the execution stage 140 may then be put back into program order in a re-order buffer 142 prior to updating the machine state in a retirement stage 144.

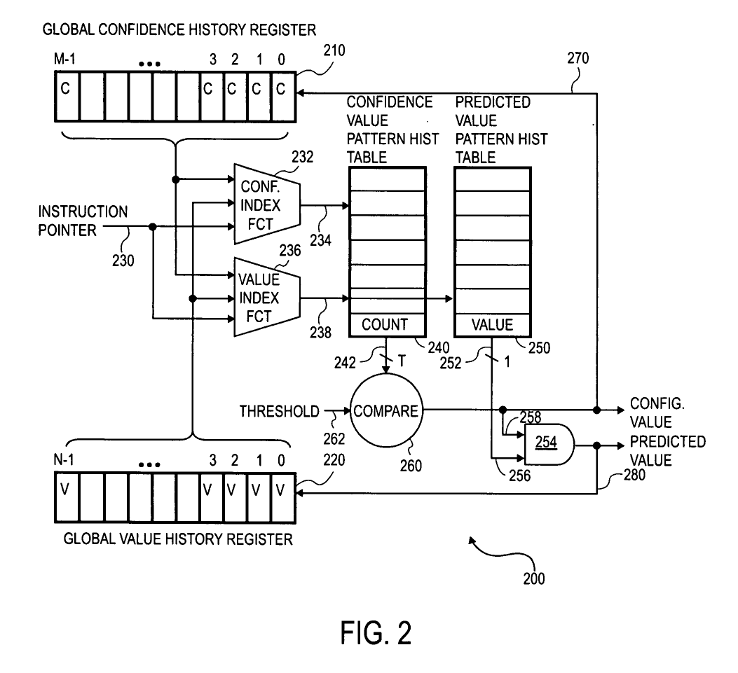

Referring now to FIG. 2, a diagram of a predictor 200 for producing a confidence value 270 and a predicted value 280 is shown, according to one embodiment. The predictor 200 may include a global confidence history register 210, a global value history register 220, a confidence value pattern history table 240, a predicted value pattern history table 250, and a pair of indexing functions: confidence index function 232 and value index function 236. In other embodiments, other combinations of circuit elements may be used. For example, the global confidence history may be stored in another form of circuit rather than a register. And the confidence value 270, shown here as a true/false signal indicating “confident” and “not confident”, may in other embodiments indicate a numerical value other than 0 and 1.

Global confidence history register 210 is shown as a shift register of M bits. Each time a prediction is made, and a corresponding confidence value signal 270 is issued, the corresponding logical value C may be left shifted into global confidence history register 210. In this manner, global confidence history register 210 may contain a global history of the most recent M confidence values corresponding to predictions made by predictor 200. Note that these global confidence history entries may be from predictions made concerning differing instructions. In other embodiments, other kinds of memory elements may be used instead of a shift register to hold the global confidence history.

Similarly, global value history register 220 is shown as a shift register of N bits. Each time a predicted value signal 280 is issued, the corresponding logical value V may be shifted into global value history register 220. In this manner, global value history register 210 may contain a global history of the most recent N predicted values corresponding to predictions made by predictor 200. In other embodiments, other kinds of memory elements may be used instead of a shift register to hold the global value history.

The global confidence history contained in global confidence history register 210 and the global value history contained in global value history register 220 may be combined with the instruction pointer (IP) 230 to index pattern history tables. In one embodiment, there is a separate confidence value pattern history table 240 and a predicted value pattern history table 250. The indexing may be performed by an index function circuit element, such as confidence index function 232 and value index function 236. In one embodiment, the index function circuit elements, confidence index function 232 and value index function 236, may perform a hashing function of the IP 230 with the contents of global confidence history register 210 and global value history register 220. The particular hashing function may be to concatenate the contents of global confidence history register 210 and global value history register 220 with a few bits of the IP 230. In other embodiments, the hashing function may be to exclusive-or the contents of global confidence history register 210 and global value history register 220 with the IP 230. The particular form of the hashing function is not significant.

In some embodiments, the indexing functions, confidence index function 232 and value index function 236, may not use all three of the contents of global confidence history register 210, the contents of global value history register 220, and the IP 230. For example, some embodiments may use the IP 230 hashed with only the contents of global confidence history register 210, or the IP 230 hashed with only the contents of global value history register 220. Similarly, the indexing functions may not use all the bits present of the contents of global confidence history register 210 and global value history register 220. In some embodiments, the indexing functions may differ between confidence index function 232 and value index function 236. In other embodiments, there may be a single index function circuit to support an undivided combined pattern history table.

In the FIG. 2 embodiment, a pair of pattern history tables are shown, confidence value pattern history table 240 and predicted value pattern history table 250. In order to prepare a predicted value, the value indexing function 236 may send an index 238 to predicted value pattern history table 250. The indexed content of predicted value pattern history table 250 may emerge as a value signal 252. In order to prepare a confidence value, the confidence indexing function 232 may send an index 234 to confidence value pattern history table 240. The indexed content of confidence value pattern history table 240 may emerge as a confidence count 242. The confidence count 242 may be compared with a threshold signal 262 in a compare circuit 260 to form a confidence value 270. In other embodiments, the confidence count 242 may itself be sent as a confidence value.

Subsequent to the prediction, when the actual (architectural) predicate value is determined, the entry in the predicted value pattern history table may be set to the architectural predicate value. The corresponding confidence count in the confidence value pattern history table 240 may be incremented by one (or another number) if the predicted value matched the architectural predicate value, or may be decremented by one (or another number) if the predicted value did not match the architectural predicate value. In one embodiment, the confidence count may be cleared, rather than decremented, if the predicted value did not match the architectural predicate value.

In the FIG. 2 embodiment, the predicted value 280 is shown as being masked by the confidence value 270 by the action of gate 254. When the confidence value 270 indicates not confident, the predicted value 280 may be suppressed as it may be considered irrelevant. This may advantageously reduce the size of the pattern history tables. In other embodiments, the confidence value 270 may not mask the predicted value 280.

The value of the threshold 262 may be determined by simulations. If the value of the threshold 262 is set too high, then there may be too few confident predictions. If the value of the threshold 262 is set too low, then there may be too many incorrect predictions and resulting recover processes. In one embodiment, a threshold value in the range of 8 to 10 may be useful. The threshold value may be used to determine the individual counter sizes within the confidence value pattern history table. In one embodiment, the individual counters which will hold the confidence count values may be implemented as saturating counters with a saturation value near that of the selected threshold value.

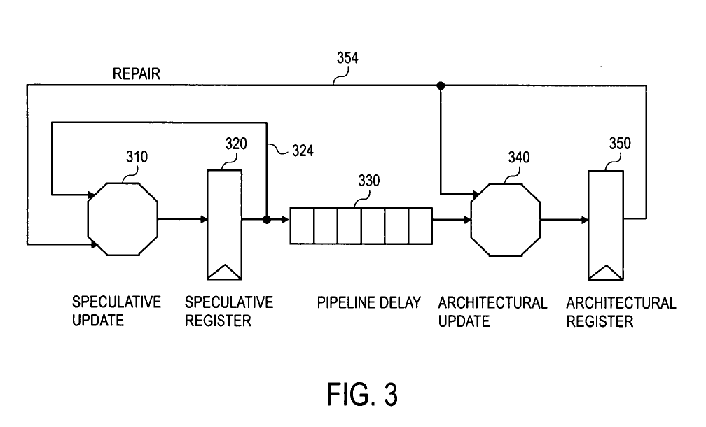

After a misprediction, the global confidence history register 210 and global value history register 220 may have their contents repaired so that the entries for the confidence value and predicted value, previously shifted in, may be set to zero. In one embodiment, this repair may be performed as shown in the discussion of FIG. 3, which now follows.

Referring now to FIG. 3, a diagram of a speculative global history register and an architectural global history register is shown, according to one embodiment. The global confidence history register 210 and global value history register 220 of FIG. 2 may in one embodiment each be replaced by a pair of similar registers, speculative register 320 and architectural register 350. During the prediction process, the portion of the predictor which may be called speculative update 310 may shift the speculative confidence value into speculative register 320 in embodiments when speculative register 320 contains a global confidence history. Similarly the speculative update 310 may shift the predicted value into speculative register 320 in embodiments when speculative register 320 contains a global value history. The global histories in speculative register 320 may then be used to support indexing functions for subsequent instructions until such time as the determination of the actual value of the predicate is made. The global histories in the speculative register 320 may be sent back to the speculative update 310 via a feedback path 324.

The actual value of the predicate may be determined during an execution stage or retirement stage after a representative pipeline delay 330. The portion of the processor which may be called architectural update 340 may write a zero in architectural register 350 upon detecting a misprediction in embodiments when architectural register 350 contains a global confidence history. Similarly the architectural update 340 may write a zero in architectural register 350 upon detecting a misprediction in embodiments when architectural register 350 contains a global value history. The contents of the architectural register 350 may be sent back to the speculative update 310 on a repair path 354. The repair may need to be made to the entire speculative register 320 because multiple predictions may be made before a misprediction is detected a the execution stage or retirement stage.

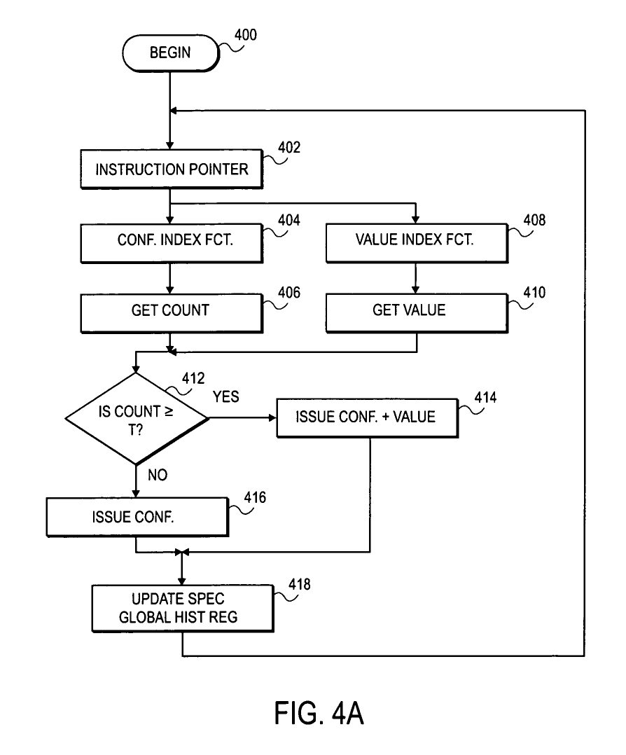

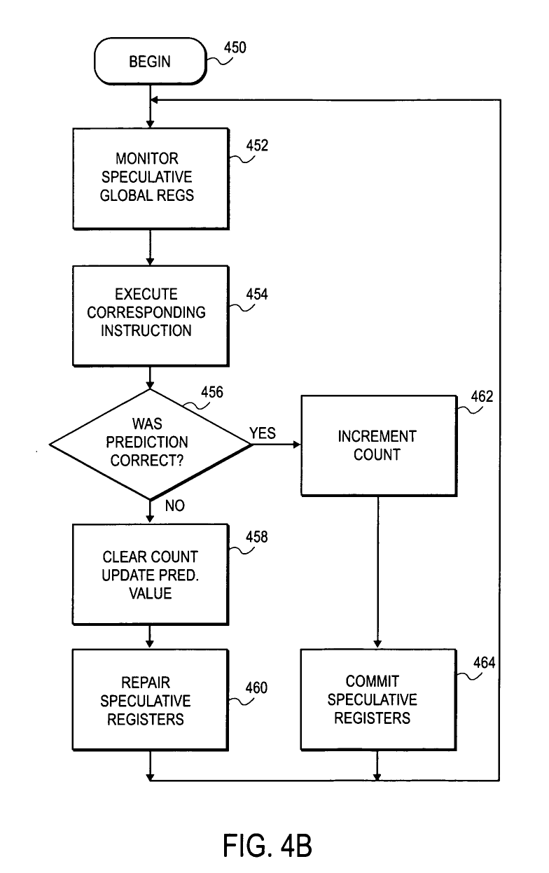

Referring now to FIG. 4, a flowchart of the operation of a predictor is shown, according to one embodiment of the present disclosure. The process begins when a new instruction pointer is received in block 402. Then this instruction pointer may be used to create an index into the confidence value pattern history table in block 404 and an index into the predicted value pattern history table in block 408. These indexes may then be used in block 406 to retrieve the confidence count from confidence value pattern history table and in block 410 to retrieve the predicted value from predicted value pattern history table.

In decision block 412 it may be determined whether the confidence count is at least as large as the threshold value T. If so, then the process exits along the YES path, and in block 414 the confidence value is issued as confident (which may be represented as logic true) and the predicted value is also issued. However, if in decision block 412 it was determined that the confidence count was less than the threshold value T, then the process exits along the NO path, and in block 416 only the confidence value is issued as not confident (which may be represented as logic false). The predicted value may be masked. This masking may cause one of three values to be issued: predicted true and confident, predicted false and confident, and not confident. The process may then update the speculative global history registers in block 418. The process may then repeat to make a subsequent prediction.

Referring now to FIG. 4B, a flowchart of the repair of speculative global history registers by the architectural global history registers is shown, according to one embodiment of the present disclosure. In block 452, the process may monitor the speculative global history registers and determine which predicates were previously predicted. In block 454, the process executes one of the corresponding instructions that calculates the predicate value. Then in decision block 456, it may be determined whether the prediction was indeed correct when compared with the actually-determined value of the predicate. If so, then the process exits along the YES path and in block 462 the indexed confidence count may be incremented. Then in block 464 the values in the speculative global history registers may be committed to the architectural global history registers. However, if in decision block 456 it is determined that the prediction was incorrect, then the process exits along the NO path and in block 458 the indexed confidence count may be cleared and the predicted value bit may be updated. Then in block 460 the speculative global history registers may be repaired.

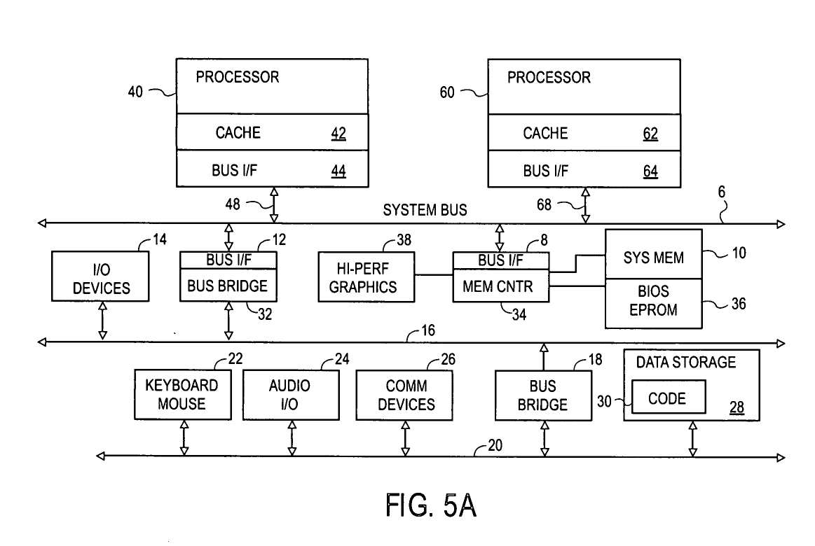

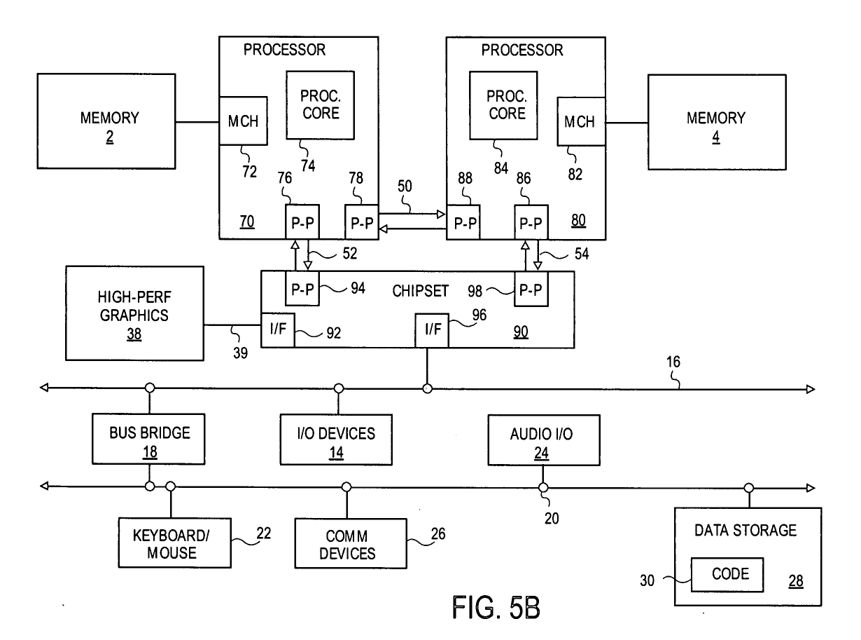

Referring now to FIGS. 5A and 5B, schematic diagrams of systems including a processor supporting a predictor capable of issuing a predicted value and a confidence value are shown, according to two embodiments of the present disclosure. The FIG. 5A system generally shows a system where processors, memory, and input/output devices are interconnected by a system bus, whereas the FIG. 5B system generally shows a system where processors, memory, and input/output devices are interconnected by a number of point-to-point interfaces.

The FIG. 5A system may include several processors, of which only two, processors 40, 60 are shown for clarity. Processors 40, 60 may include level one caches 42, 62. The FIG. 5A system may have several functions connected via bus interfaces 44, 64, 12, 8 with a system bus 6. In one embodiment, system bus 6 may be the front side bus (FSB) utilized with Pentium® class microprocessors manufactured by Intel® Corporation. In other embodiments, other busses may be used. In some embodiments memory controller 34 and bus bridge 32 may collectively be referred to as a chipset. In some embodiments, functions of a chipset may be divided among physical chips differently than as shown in the FIG. 5A embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct read data from system memory 10 to the high-performance graphics circuit 38 across high-performance graphics interface 39.

The FIG. 5B system may also include several processors, of which only two, processors 70, 80 are shown for clarity. Processors 70, 80 may each include a local memory controller hub (MCH) 72, 82 to connect with memory 2, 4. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. Chipset 90 may also exchange data with a high-performance graphics circuit 38 via a high-performance graphics interface 92.

In the FIG. 5A system, bus bridge 32 may permit data exchanges between system bus 6 and bus 16, which may in some embodiments be a industry standard architecture (ISA) bus or a peripheral component interconnect (PCI) bus. In the FIG. 5B system, chipset 90 may exchange data with a bus 16 via a bus interface 96. In either system, there may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a first circuit to store a global confidence history;
a second circuit to store a global prediction value history;
a first index function to produce a first index signal from said global confidence history; and
a first pattern history table to retrieve a value responsive to said first index signal.

2. The apparatus of claim 1, wherein said first index function to use an instruction pointer signal.

3. The apparatus of claim 2, wherein said first index function to use said global prediction value history.

4. The apparatus of claim 1, wherein said first pattern history table to store a confidence count.

5. The apparatus of claim 4, wherein said confidence count to increment subsequent to a correct prediction.

6. The apparatus of claim 4, wherein said confidence count to decrement on an incorrect prediction.

7. The apparatus of claim 4, wherein said confidence count to clear on an incorrect prediction.

8. The apparatus of claim 4, wherein said confidence count to form a confidence value signal by utilizng a threshold.

9. The apparatus of claim 7, wherein said confidence value signal to update said global confidence history.

10. The apparatus of claim 7, further comprising a second pattern history table to retrieve a predicted value.

11. The apparatus of claim 10, wherein said confidence value signal to mask said predicted value.

12. The apparatus of claim 11, wherein said apparatus to issue a predicted value signal including combinations predicted true and confident, predicted false and confident, and not confident.

13. The apparatus of claim 1, wherein said first circuit and said second circuit are speculative registers.

14. The apparatus of claim 13, further comprising a third circuit to store an architectural global confidence history, and a fourth circuit to store an architectural global prediction value history, wherein said third circuit to update said first circuit and said fourth circuit to update said second circuit.

15. A method, comprising:
creating a first index using a global confidence history; and
applying said first index to a pattern history table to retrieve a value.

16. The method of claim 15, wherein said creating also uses an instruction pointer.

17. The method of claim 15, wherein said creating also uses a global prediction value history.

18. The method of claim 15, wherein said value includes a confidence count.

19. The method of claim 18, further comprising comparing said confidence count to a threshold.

20. The method of claim 19, further comprising issuing a confidence value responsive to said comparing.

21. The method of claim 20, further comprising updating said global confidence history with said confidence value.

22. The method of claim 18, wherein said confidence count is reset subsequent to an incorrect prediction.

23. A system, comprising:
a processor including a first circuit to store a global confidence history, a first index function to produce a first index signal from said global confidence history, and a first pattern history table to retrieve a value responsive to said first index signal
an interface to couple said processor to an input/output circuit; and
an audio input/output circuit.

24. The system of claim 23, wherein said first index function to use an instruction pointer signal.

25. The system of claim 24, wherein said first index function to use said global prediction value history.

26. The system of claim 23, wherein said first pattern history table to store a confidence count.

27. The system of claim 26, wherein said confidence count to increment subsequent to a correct prediction.

28. The system of claim 26, wherein said confidence count to clear on an incorrect prediction.

29. The system of claim 26, wherein said confidence count to form a confidence value signal by utilizing a threshold.

30. The system of claim 29, wherein said confidence value signal to update said global confidence history.

31. The system of claim 26, further comprising a second pattern history table to retrieve a predicted value.

32. The system of claim 26, wherein said confidence value signal to mask said predicted value.

33. The system of claim 32, wherein said apparatus to issue a predicted value signal including combinations predicted true and confident, predicted false and confident, and not confident.

34. The system of claim 23, wherein said first circuit and said second circuit are speculative registers.

35. The system of claim 34, further comprising a third circuit to store an architectural global confidence history, and a fourth circuit to store an architectural global prediction value history, wherein said third circuit to update said first circuit and said fourth circuit to update said second circuit.

36. An apparatus, comprising:
means for creating a first index using a global confidence history; and
means for applying said first index to a pattern history table to retrieve a value.

37. The apparatus of claim 36, wherein said creating also uses an instruction pointer.

38. The apparatus of claim 36, wherein said creating also uses a global prediction value history.

39. The apparatus of claim 36, wherein said value includes a confidence count.

40. The apparatus of claim 39, further comprising comparing said confidence count to a threshold.

41. The apparatus of claim 40, further comprising issuing a confidence value responsive to said comparing.

42. The apparatus of claim 41, further comprising updating said global confidence history with said confidence value.

43. The apparatus of claim 39, wherein said confidence count is reset subsequent to an incorrect prediction.
